(19) United States
(12) Patent Application Publication
(10) Pub. No.: US 2006/0200294 A1
(43) Pub. Date: Sep. 7, 2006

(54) Electronic machine management system

(76) Inventors: Bernd Scheufler, Hasberg (DE); Johannes Marquering, Borgloh (DE); Michael Quinckhardt, Warendorf (DE); Ludger Autermann, Drensteinfurt (DE)

Correspondence Address: STRIKER, STRIKER & STENBY, 103 EAST NECK ROAD, HUNTINGTON, NY, 11743, US

(21) Appl. No.: 11/358,775

(22) Filed: Feb. 21, 2006

(30) Foreign Application Priority Data
Feb. 21, 2005 (DE) 10 2005 008 105.3

(51) Int. Cl. G06F 19/00

(52) U.S. Cl. 701/50; 701/41

(57) ABSTRACT

An electronic machine management system for initiating switching and actuating procedures with positional accuracy in agricultural working machines, has a geographic module for determining a current position, and based on information regarding positions of critical field data, quantities to be applied, field boundaries, work areas and/or areas to be avoided, and a machine-specific module that contains machine-specific functionalities, the modules being configured so that the geographic modules supplying the machine-specific module with geographic information in real time, and, based on the geographic information in real time, the machine-specific module generating machine-specific switching and actuating procedures in real time and sending signals relevant thereto to particular switching and actuating elements.

### BACKGROUND OF THE INVENTION

The present invention relates to an electronic machine management system.

Agricultural working machines are equipped with fieldwork computer systems with which switching and actuating procedures can be initiated and/or carried out by agricultural machines with positional accuracy. These fieldwork computers include a position-finding system (GPS) with which the actual position of the working machines on the field to be worked can be determined in real time. Previously, fieldwork computer systems were designed especially for a single working machine or a group of working machines from the same manufacturer. Some tractors that carry or pull the working machines are also equipped with an additional and/or separate fieldwork computer system, although this fieldwork computer system is not capable of initiating actuating procedures in the working machines attached or coupled to the tractors, or to control or regulate these working machines. These functions are carried out by the aforementioned fieldwork computer, which is tailored especially to the particular working machine or a group of working machines.

### SUMMARY OF THE INVENTION

The object of the present invention is to provide assistance in this regard and create a universal machine management system and a fieldwork computer system that communicate with each other.

In keeping with these objects and with others which will become apparent hereinafter, one feature of the present invention resides, briefly stated, in an electronic machine management system for initiating switching and actuating procedures with positional accuracy in agricultural working machines, the electronic machine management system, comprising a geographic module for determining a current position, and based on information regarding positions of critical field data, quantities to be applied, field boundaries, work areas and/or areas to be avoided; and a machine-specific module that contains machine-specific functionalities, said modules being configured so that said geographic modules supplying said machine-specific module with geographic information in real time, and, based on the geographic information in real time, said machine-specific module generating machine-specific switching and actuating procedures in real time and sending signals relevant thereto to particular switching and actuating elements.

As a result of these measures, a geographic module is basically assigned to the tractor, and a machine-specific module of the electronic machine management system is assigned to the working machine.

According to the present invention, the geographic and machine-specific modules communicate with each other. As such, they are the fieldwork computer itself. The geographic module delivers information about the position and relevant, stored data and information such as critical field data, areas to be avoided, etc., e.g., from the installed farm management software. In accordance with the stored, machine-related data, the machine-specific module subsequently initiates the particular action required, at the correct time or in the correct location. The machine-specific module generates the necessary machine switching procedures, such as turning on and/or adjusting the dosing devices, folding the spreader arms inward or outward, or lifting or lowering the machine or the working tools on the machine.

The two modules must communicate with each other because the machine-specific module does not know which switching procedures need to be carried out on the machine. Nor does the machine-specific module know the position on the field where the machine is located at that time, nor what part of the machine must be actuated next based on critical field data, etc. For example, it does not know how far away the turnaround or another “event” is. The machine-specific module needs the geometric information from the geographic module and, based on this information, generates the corresponding machine-specific procedures.

In one embodiment, the geographic and machine-specific modules communicate with each other about the geometric properties of the machine and/or the position of the. GPS antenna, so the machine-specific module can calculate a virtual antenna position or the geographic module can correct the current position in a machine-relevant manner. For example, the machine unit is located 5 m behind and 3 m to the right of the antenna position. In this case, the geographic module subsequently calculates the current position of this unit, because it knows the distances to the GPS antenna, and the direction. It is possible, however, for the machine-specific module to receive this additional information (direction and antenna distances) and to calculate the position.

Using the electronic machine and management system as described above, actions can be carried out at the positions and/or in situations described below, among others.

A critical area can be detected. The geographic module detects the critical area via receipt of the geometric dimensions from the attached device. Based on the measured GPS position and the direction and/or ground speed, the upcoming area to be worked can be monitored for critical areas. Critical areas are, e.g., turnaround areas, obstacles, previously-worked areas, areas where special work must be carried out, e.g., strips of land at the edges, where spraying and fertilizing must be reduced, and areas to be avoided.

The geographic module can receive the geometric dimensions of the working device from the machine-specific module. The “geographic dimension of the device” is intended to mean the working width of the entire machine, e.g., the working widths of the additional machines, including their properties (e.g., they can be folded inward, they can be lifted upward). This information is stored in the farm management software or in the geographic module and is subsequently communicated to the machine-specific module. The GPS position, with direction and/or ground speed, is monitored permanently. The GPS position, direction and/or ground speed are variables to be measured and can be determined using the GPS receiver and/or the on-board sensor system.

The upcoming area to be worked is also monitored. Based on the measured GPS position, the direction and/or ground speed, the upcoming area to be worked can be calculated in advance, and the critical areas can be detected. The machine-specific module in the combine-mounted device or the attached device receives the information regarding critical areas from the geographic module and responds to it in a manner that is appropriate for the situation. In the simplest case, the only information communicated to the machine-specific module in the combine-mounted device is the difference in terms of time or space.

If the critical area is a turnaround area, the automated turnaround system and/or sequence is started when the event occurs. If the critical area is an area to be avoided, these units are switched off or on, depending on the situation. If the critical area is an obstacle, this is communicated to the machine-specific module of the device, which responds in a manner appropriate for the situation, e.g., it folds the arms inward, actuates the actuating components or switching components of the dosing devices, or lifts the unit. If a previously-worked area is detected, subunits are switched on or off to prevent the area from being worked a second time. This is the case, e.g., in wedge-shaped areas.

The distance (space/time) to the critical area is communicated continuously by the geographic module to the machine-specific module. The machine-specific module is notified of the temporal or geographic distance to the critical area. The appropriate action can be initiated and/or carried out by the machine-specific module by way of an intelligence stored in the machine-specific module.

If a turnaround is detected by the geographic module as the critical area, the machine-specific module can start the automated turnaround system or a sequence for the machine in a situation-specific manner. The same applies for leaving the turnaround area. Depending on the combine-mounted device, this can take place with a displacement as to time or position that has been adjusted and/or received from the machine-specific module in the device. The displacement can be forward or backward.

If the critical area is, e.g., transverse areas or other critical areas, the machine or machine parts can be switched on or off automatically via the machine-specific module, similar to the procedure used in the turnaround area.

In addition, the machine or working device can avoid obstacles on the field via the interaction between the geographic and machine-specific modules. Obstacle-related data include the position of the obstacle on the field, and other specific parameters, e.g., whether it can be driven around or over, what is the safe distance, etc. Based on this information, the machine-specific module can, e.g., lift units on the machine, fold the machine arms inward, or switch off the dosing devices.

In addition, the worked area can be recorded permanently in the geographic or machine-specific modules.

If the previously-worked area is detected as the critical area, it is regarded as an area to be avoided, to prevent it from being worked a second time, and the machine-specific module can respond accordingly. Wedge-shaped areas are often encountered, where the machine-specific module can automatically turn off the device in stages—depending on the capabilities of the device—from the outside inward, or it can switch from one side to the other.

An automated path switching functionality is also stored in the machine-specific module. With this functionality, the path sequence is detected automatically and transmitted to the machine. The information regarding the path sequence is taken either from the farm management software or it is generated “on the go” in the field. The paths can also be recorded in the machine-specific module, of course, so this data can be used as processing and/or control recommendations for the tractor that carries or pulls the working machine, e.g., in subsequent work such as spraying or spreading fertilizer.

If a path model is not specified by the farm management software as the model, the path sequence can be determined automatically in the field. The input variables for this are the current GPS position and the GPS records of the previous paths and/or a generation based on a driven contour of the field to be worked. The appropriate intelligence is stored in the memory of the geographic or machine-specific module.

In another case, the path model is taken from the farm management software. This is used, e.g., to utilize the same paths every year.

The path sequence can also be detected automatically. Based on the current position, a path sequence can be derived in the geographic module and transmitted to the maschine-specific module. The machine-specific module can turn the units on or off, e.g., path markers, the automated path system, or advance path markings.

The position of the paths is recorded in the machine-specific module and evaluated in the farm management software so this information can be used for subsequent work. A recommendation for work can also be stored in the geographic module. This module provides the guidance/steering system with the information about the planned work and guides the machine accordingly. Information about performing the work can be planned in the farm management software or generated “on the go”.

In the geographic module, reference information can be obtained from the farm management software for the guidance/steering system. The working path is planned in the farm management software so the field can be worked in the same manner every year.

In addition, new reference “target” lines can be generated on the field. If a known working path is not available, the target line can also be generated automatically “on the go” in the geographic module based on an outer contour that was driven around.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 Shows a diagram of the data stored in the graphic and machine module,

FIG. 2 Shows a field to be worked, with paths laid out, in a schematic depiction, and

FIG. 3 Shows another field with paths laid out, in a schematic depiction.

### DESCRIPTION OF THE PREFERRED EMBODIMENTS

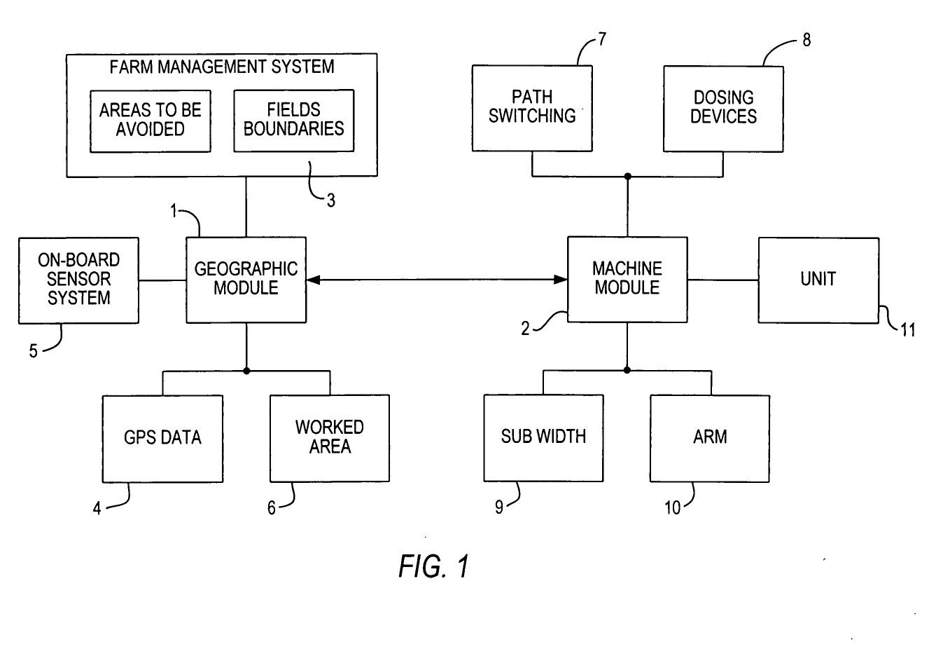

As shown in FIG. 1, the electronic machine management system includes a geographic module 1 and machine-specific module 2. The following are stored in the geographic module: The software for farm management system 3 with the areas to be avoided and field boundaries, and GPS data module 4, the model for the on-board sensor system, e.g., to detect the ground speed, and module 6 for recording the areas to be worked. Corresponding memory locations are provided, from which these data can be called up or in which they can be stored. The following, among other things, are stored in machine-specific module 2: Data regarding switching between paths 7, dosing devices 8, partial widths 9 and properties of arm 5 and the units, such as lifting and lowering a cutting mechanism or header, or a ground working tool.

Using this machine management system, positionally accurate switching and actuating procedures can be initiated in agricultural machines with positional accuracy. The management system contains a geographic module 1 for determining the current position. Based on the current position determined using GPS and data stored in the geographic module, information about positions of critical field data, quantities to be applied, field boundaries, worked areas and/or areas to be avoided, and additional data can be obtained.

In addition, the management system includes a machine-specific module 2 that contains machine-specific functionalities, e.g., data pertaining to switching between paths, data and properties of the dosing devices, data regarding sub-widths of the machine, and data and properties of the arm. The geographic module transmits the geographic information to machine-specific module 2 in real time, i.e., the geographic module determines its actual position in the field to be worked during the working or harvesting procedure. Based on the geographic information that geographic module 1 transmits to machine-specific module 2, machine-specific module 2 generates the machine-specific switching and actuating procedures in real time and sends signals related thereto to the particular switching and actuating elements of the machine.

The geographic information contains temporal and/or geographical distances from paths adjacent to field boundaries, adjacent paths, an adjacent working area, the turnaround, areas to be avoided and/or obstacles.

A program is stored in geographic module 1 that calculates, in a predicting manner, the temporal and/or geographic distances to the next critical event based on the current ground speed and direction.

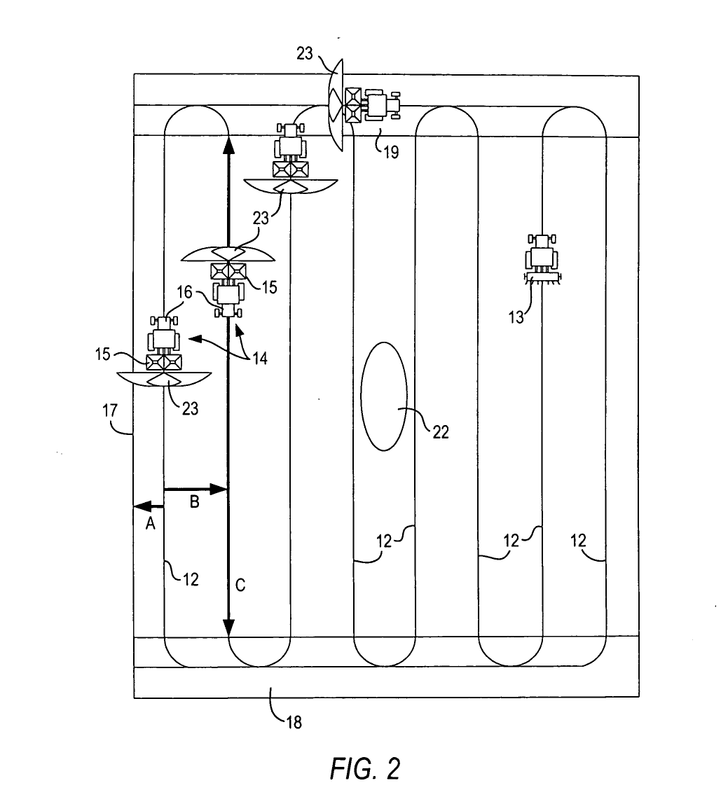

FIG. 2 shows a schematic depiction of a field on which paths 12 have been created when the field was sowed with a sowing machine 13. Paths 12 were laid out using the electronic machine management system. To control machine 14, e.g., a fertilizer broadcaster 15 with tractor 16, along path 12, geographic module 1 can determine—in the present exemplary embodiment—distance A on the left—relative to the direction of travel—to field boundary 17 to the obstacle or to next path 12, distance B on the right side to next path 12/field boundary or an obstacle, and communicate it machine-specific module 2. In addition, geographic module 1 can determine distance C ahead—relative to the direction of travel—to next turnaround 18 as stated in terms of distance, time and speed. In addition, geographic module 1 can communicate distance D to the rear to previous turnaround 19, stated in terms of time, distance or speed. If vehicle 14, 16 with working machine 15 is located at field boundary 17 or in turnaround 18, 19, this is determined by geographic module 1 and communicated to machine-specific module 2.

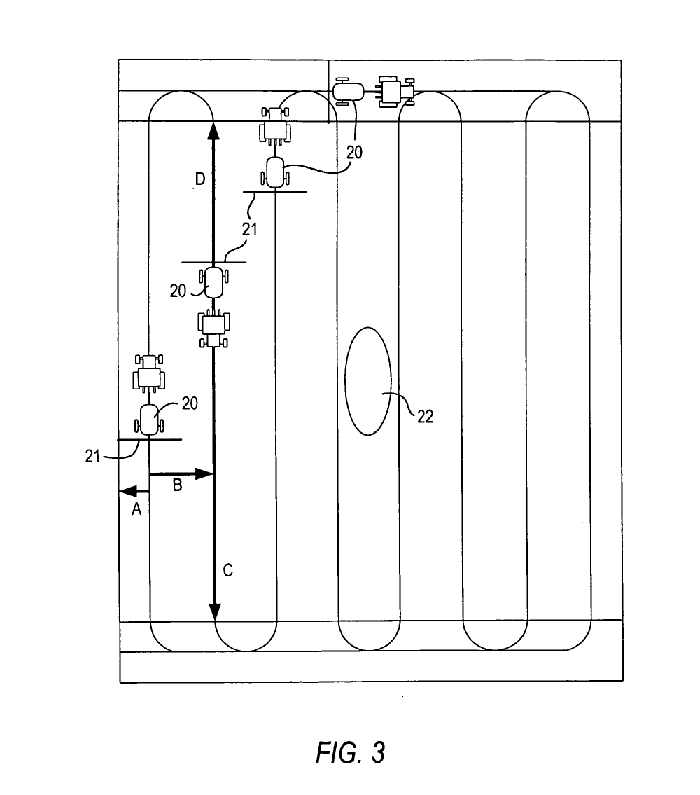

The field being worked with a field sprayer 20 that includes an arm 21 is depicted in the exemplary embodiment shown in FIG. 3. In this case as well, distances A, B, C, D described above with reference to FIG. 2 are determined by geographic module i and communicated to machine-specific module 2.

The position of areas to be avoided 22 is also detected by geographic module 1. When these areas to be avoided 22 are reached, the position of these areas to be avoided 22 is transmitted to machine-specific module 2.When fertilizer is applied using a fertilizer broadcaster 15 as depicted in FIG. 2, the fertilizer is distributed broadly in the shape of a fan 23, as depicted schematically. Geographic module 1 receives the geographic dimensions of the attached device from machine-specific module 2. Based on the GPS position measured using geometric module 1, the direction in which the vehicle and/or the working machine is moving, and the ground speed, the upcoming area to be worked can be monitored for critical areas.

When machine 15, 20 reaches turnaround 18, 19, the turnaround area is detected. When machine 15, 20 reaches area to be avoided 22, this is also detected. In addition, other obstacles—which also include areas to be avoided 22—can be detected. Previously-worked areas are also detected. During travel through turnaround 18, 19 and at field boundary 17, as shown in FIG. 2, the quantity to be applied and the casting width of the fertilizer pellets is reduced by adjusting fertilizer broadcaster 15 accordingly based on the actuating elements of fertilizer broadcaster 15 controlled by machine-specific module 2, so that a reduced amount of fertilizer is applied to the strips of land at the edges.

When machine 16 with fertilizer broadcaster 15 reaches turnaround 18, 19, this is detected by geographic module 1 and communicated to machine-specific module 2, so that the actuating or switching elements of the dosing devices of broadcast fertilizer 15 are triggered by machine-specific module 2 at the right time, so that the fertilizer feed is interrupted in a timely manner. After the machine has turned around at the end of the field, left the turnaround and entered the interior of the field, this is detected by geographic module 1, and relevant data are transmitted to machine-specific module 2, so that machine-specific module 2 transmits appropriate signals to the switching and actuating elements of the dosing devices at the right time, so that the fertilizer feed to the application elements is interrupted at the right time, so that the field is therefore fertilized properly.

The following train of thought is followed in terms of transmitting this information. Geographic module 1 determines the actual position via GPS data, and determines the distance to the critical areas. These data are transmitted by geographic module 1 to machine-specific module 2, so that machine-specific module 2 can control and regulate the switching and actuating elements of the combine-mounted device accordingly, so that the combine-mounted device responds in a manner that is appropriate for the situation.

In the simplest case, the only information communicated to machine-specific module 2 of combine-mounted device 15 is the distance in terms of time or space. If the critical area is a turnaround area 18, 19, the automated turnaround system and/or sequence is started by machine-specific module 2 when the event occurs. If the critical area is an area to be avoided 22, the units are switched off or on, depending on the situation. If the critical area is an obstacle, this is also processed by machine-specific module 2 in a manner appropriate for the situation, so that corresponding switching and actuating elements are triggered, so that the combine-mounted device responds appropriately for the situation, e.g., arm 21 is folded inward or the unit is lifted. If a previously-worked area is detected, subunits are switched on or off to prevent the area from being worked a second time.

Geographic module 1 determines the distance—in terms of time and geography—to the critical area and communicates this continuously to the machine-specific module. Via intelligence stored in its memory, machine-specific module 2 subsequently triggers the corresponding actions to be carried out by combine-mounted devices 15.

Information about obstacles 22 or areas to be avoided or other critical areas are stored in the farm management system in geographic module 1. Information about these obstacles 22 includes, e.g., their position in the field and their parameters, e.g., whether they can be driven around or over, the safe distance, etc. With this information, which is transmitted to machine-specific module 2, appropriate actions are subsequently triggered by machine-specific module 2, e.g., lift the unit, turn the dosing device on or off, change the setting of the dosing device, fold the arm outward, etc.

The worked area is recorded permanently in geographic module 1 in a memory. If the previously-worked area is detected as the critical area, it is regarded as an area to be avoided 22, to prevent it from being worked a second time. The corresponding information is transmitted to machine-specific module 2, so that machine-specific module 2 can control or regulate the machine accordingly, so that the device responds accordingly.

The paths laid out in FIG. 2 can be detected automatically by geographic module 1 and communicated and transmitted accordingly to machine-specific module 2. This information regarding the path sequence is taken either from the farm management software or it is generated “on the go” in the field. This information as to how the paths are laid out on the field is also communicated to machine-specific module 2 in a manner that is appropriate for the situation. The paths can also be recorded in geographic module 1 or machine-specific module 2, of course, so that, e.g., subsequent work such as spraying or spreading fertilizer, is used as a processing or control recommendation.

If no path models are specified by the farm management software, the path sequence can be determined automatically by geographic module 1 based on a stored program. The input variables for this are the current GPS position and the GPS record of the previous paths and/or a generation, e.g., from a contour of the field that was driven. When path models stored in the farm management software are used, the path model is taken from the farm management software. This allows the same paths to be laid out and used every year.

A path sequence can be derived based on the current position of the device, so that the path sequence is detected automatically. This is carried out by the geographic module, which subsequently forwards the data to the machine-specific module. The machine-specific module can turn the units on or off, e.g., path markers, the automated path system, or advance markings of a sowing machine to lay out the paths. These paths are recorded in geographic module 1 and evaluated in the farm management software so this information can be used for subsequent work. Subsequent work includes, e.g., spreading fertilizer using a broadcast fertilizer or applying herbicides using a field sprayer.

Geographic module 1 can contain information about the planned work and forwards it to the guidance/steering system of the tractor, so that the machines can be guided automatically based on these data. This information regarding processing can be planned in the farm management software or it can be generated “on the go” in that the predetermined distance from the field boundary or the previously worked path is determined and the guidance/steering system subsequently controls the machine accordingly.

The purpose and advantage of planning the working path in the farm management software are, e.g., that the field can be worked in the same manner every year.

If a planned working path is not available, the target line can also be generated automatically “on the go” by graphic module 1 based on an outer contour that was driven around by the tractor.

The electronic machine management system with geographic module 1 and machine-specific module 2 is realized via an intelligent link between geographic module 1—which is the tractor terminal—and the machine-specific module, which is the job computer of the working device. Appropriate programs and data parts must be stored in the memory of the particular modules.

The electronic machine management system can be used in self-propelled, drawn and attached working machines such as combine harvesters, forage harvesters, hay harvesting and mowing machines, broadcast fertilizers, sowing machines, field sprayers, ground-working devices and machines, etc.

It will be understood that each of the elements described above, or two or more together, may also find a useful application in other types of constructions differing from the types described above.

While the invention has been illustrated and described as embodied in an electronic machine management system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention. What is claimed as new and desired to be protected by Letters Patent is set forth in the appended claims.

1. An electronic machine management system for initiating switching and actuating procedures with positional accuracy in agricultural working machines, the electronic machine management system comprising a geographic module for determining a current position, and based on information regarding positions of critical field data, quantities to be applied, field boundaries, work areas and/or areas to be avoided; and a machine-specific module that contains machine-specific functionalities, said modules being configured so that said geographic modules supplying said machine-specific module video graphic information in real time, and, based on the geographic information in real time, said machine-specific module generating machine-specific switching and actuating procedures in real time and sending signals relevant thereto to particular switching and actuating elements.

2. An electronic machine management system as defined in claim 1, wherein said geographic module is configured so that the geographic information contains temporal and/or geographic distances from paths adjacent to field boundaries, an adjacent working area, a turnaround areas to be avoided, and/or obstacles.

3. An electronic machine management system as defined in claim 1, wherein said geographic module is configured so that a program is stored in a memory of said geographic module that calculates, in a predicted manner, temporal and/or geographic distance to a next critical event based on a current ground speed and direction.

4. An electronic machine management system as defined in claim 1, wherein said geographic module is configured for detecting critical areas and receives, from said machine-specific module, geographic dimensions of the critical area, and an upcoming area to be worked in the critical areas is monitored based on a measured GPS position, a direction and/or ground speed.

5. An electronic machine management system as defined in claim 1, wherein said machine-specific module is configured so that information regarding a working width of machines that follow is stored in said machine-specific module along with their properties.

6. An electronic machine management system as defined in claim 6, wherein said machine-specific modules is configured so that it stores the information regarding the working width of the machines, the working width of the machines that follow, selected from the group consisting of submachines, fertilizer spreaders, and field sprayers, and stores the properties of the machines selected from the group consisting of whether they can be folded inwards and lifted.

7. An electronic machine management system as defined in claim 1, wherein said geographic module is configured so that it determines a GPS position, a direction and/or ground speed with a GPS receiver or an on-board sensor system.

8. An electronic machine management system as defined in claim 1; and further comprising means for calculating upcoming area to be worked in advance based on a GPS position, a direction and/or ground speed thereby allowing critical areas to be determined.

9. An electronic machine management system as defined in claim 1, wherein said machine-specific module is configured so that, based on information regarding critical areas, said machine-specific module controls a combine-limited mounted device in a manner appropriate for a situation.

10. An electronic machine management system as defined in claim 1, wherein said geographic module is configured so that it continuously communicates a temporal or geographic distance to a critical area to said machine-specific module, and that, when the critical area is reached, said machine-specific module executes corresponding information via an intelligence stored accordingly in said machine-specific module.

11. An electronic machine management system as defined in claim 1; and further comprising a system selected from the group consisting of a geographic system and a machine-specific system and configured so that when a turnaround is detected, and an automated turnaround system or sequence is started by said machine-specific module in a manner that is appropriate for a situation.

12. An electronic machine management system as defined in claim 1, wherein said modules are configured so that when a critical area is detected by said geographic module or said machine-specific module, corresponding machine components are switchable on or off automatically by said machine-specific module.

13. An electronic machine management system as defined in claim 1, wherein said geographic module and said machine-specific module are configured so that when an obstacle is detected by said geographic module or said machine-specific module, said geographic module or said machine-specific module triggers a machine to drive around or over the obstacle and/or based on this information, to lift units, fold arms inward or to turn off machine components.

14. An electronic machine management system as defined in claim 1, wherein said geographic module and said machine-specific module are configured so that a working area is permanently reported in a memory of said geographic module and said machine-specific module so that if an area already worked is recognized as being a critical area, it is considered an area to be avoided, to prevent it from being worked a second time, and said machine-specific module responds accordingly.

15. An electronic machine management system as defined in claim 1, wherein at least one of said geographic module and said machine-specific module is configured so that it automatically detects a path sequence and transmits it to said machine-specific module.

16. An electronic machine management system as defined in claim 1; and further comprising means for taking an information regarding a path sequence from a farm management software.

17. An electronic machine management system as defined in claim 1, wherein said geographic module is configured so that an information regarding a path sequence is taken by said geographic module “on the go” in a field.

18. An electronic machine management system as defined in claim 1; and further comprising a farm management system configured so that a position of paths is recorded in a module selected from the group consisting of said geographic module and said machine-specific module and is evaluated in said farm management system.

19. An electronic machine management system as defined in claim 1, wherein said geographic module is configured so that it supplies a guidance/steering system with information about a planned work to be carried out and subsequently guides a machine on a field.
